(19) United States
(12) Patent Application Publication
(10) Pub. No.: US 2021/0066734 A1
(43) Pub. Date: Mar. 4, 2021

(54) REDOX FLOW BATTERY SYSTEM

(71) Applicants: DENSO CORPORATION, Kariya-city (JP); WASEDA UNIVERSITY, Tokyo (JP)

(72) Inventors: Kan KITAGAWA, Kariya-city (JP); Kenji NAKAMURA, Kariya-city (JP); Hiroaki YOTOU, Kariya-city (JP); Atsushi NAKAJIMA, Kariya-city (JP); Kenichi OYAIZU, Tokyo (JP); Kan HATAKEYAMA, Tokyo (JP); Yota SUGAI, Tokyo (JP)

(21) Appl. No.: 17/001,964

(22) Filed: Aug. 25, 2020

(30) Foreign Application Priority Data
Aug. 30, 2019 (JP) 2019-158508

(51) Int. Cl. H01M 8/04186; H01M 8/18; H01M 8/04082

(52) U.S. Cl. CPC H01M 8/04186; H01M 8/04201; H01M 8/188

(57) ABSTRACT

A redox flow battery system includes a redox flow battery cell, a first circulation mechanism, and a second circulation mechanism. The redox flow battery cell includes a positive electrode chamber housing a positive electrode, a negative electrode chamber housing a negative electrode, and a separator separating the positive electrode chamber and the negative electrode chamber. The first circulation mechanism and the second circulation mechanisms circulate electrolytic solutions into the positive electrode chamber and the negative electrode chamber, respectively. The separator is a porous body. Each of the electrolytic solutions contains an active material and a mediator that has a diameter larger than pore distribution d50 of the separator.

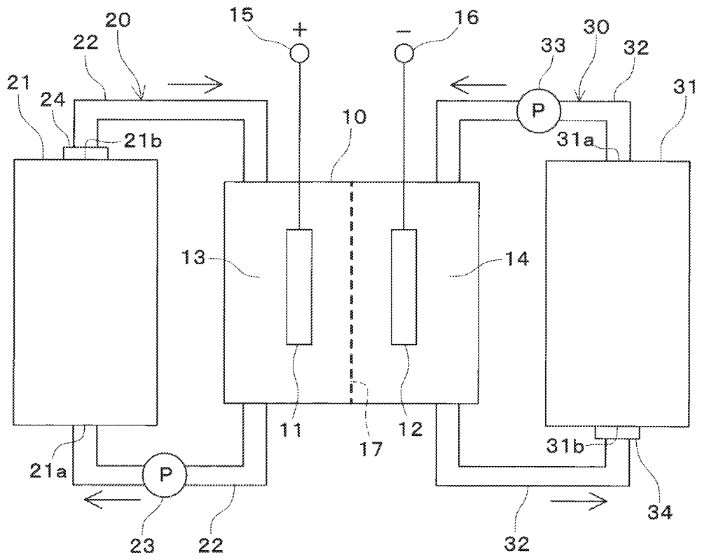

### CROSS REFERENCE TO RELATED APPLICATION

The present application claims the benefit of priority from Japanese Patent Application No. 2019-158508 filed on Aug. 30, 2019. The entire disclosure of the above application is incorporated herein by reference.

### TECHNICAL FIELD

The present disclosure relates to a redox flow battery system.

### BACKGROUND

Conventionally, there has been known a redox flow battery system that includes a redox flow battery cell and an electrolytic solution tank storing an electrolytic solution containing an active material. The redox flow battery system circulates and supplies the electrolytic solution to the redox flow battery cell.

### SUMMARY

The present disclosure provides a redox flow battery system including a redox flow battery cell, a first circulation mechanism, and a second circulation mechanism. The redox flow battery cell includes a positive electrode chamber housing a positive electrode, a negative electrode chamber housing a negative electrode, and a separator separating the positive electrode chamber and the negative electrode chamber. The first circulation mechanism and the second circulation mechanisms circulate electrolytic solutions into the positive electrode chamber and the negative electrode chamber, respectively. The separator is a porous body. Each of the electrolytic solutions contains an active material and a mediator that has a diameter larger than pore distribution d50 of the separator.

### BRIEF DESCRIPTION OF DRAWING

Objects, features and advantages of the present disclosure will become apparent from the following detailed description made with reference to the accompanying FIGURE.

The FIGURE is a conceptual diagram of a redox flow battery system according to an embodiment of the present disclosure.

### DETAILED DESCRIPTION

There is a redox flow battery system in which a mediator is dissolved in each electrolytic solution on a positive electrode side and a negative electrode side, and a porous film or an electrolyte film is used as a separator for separating the positive electrode side and the negative electrode side of a battery cell.

However, when the porous film is used as the separator, the mediator on the positive electrode side and the mediator on the negative electrode side may be mixed with each other, which may cause failure or deterioration of the battery cell. On the other hand, when the electrolyte film is used as the separator, mixing of the mediator can be prevented, but solid electrolytes have low ionic conduction speeds and it is difficult to achieve high output. Furthermore, solid electrolytes are expensive.

A redox flow battery system according to an aspect of the present disclosure includes a redox flow battery cell, a first circulation mechanism, and a second circulation mechanism. The battery cell has a positive electrode chamber housing a positive electrode, a negative electrode chamber housing a negative electrode, and a separator separating the positive electrode chamber and the negative electrode chamber. The first circulation mechanism circulates a positive electrode electrolytic solution into the positive electrode chamber. The second circulation mechanism circulates a negative electrode electrolytic solution into the negative electrode chamber. The positive electrode electrolytic solution includes a positive electrode active material and a positive electrode mediator. The negative electrode electrolytic solution includes a negative electrode active material and a negative electrode mediator. The separator is a porous body. Each of the positive electrode mediator and the negative electrode mediator has a diameter larger than a pore distribution d50 of the separator,

According to the above configuration, since the diameter of the positive electrode mediator and the diameter of the negative electrode mediator are larger than the pore distribution d50 of the separator, the positive electrode mediator and the negative electrode mediator can be restricted from being mixed with each other even when a porous film is used as the separator.

Further, by using the porous film as the separator, an ionic conductivity can be made higher than an ionic conductivity in the case of using an electrolyte film. Accordingly, the power density of the redox flow battery system can be increased,

Hereinafter, an embodiment of the present disclosure will be described with reference to the drawings. A redox flow battery system according to the present embodiment may be mounted on a moving body, such as a vehicle, to be used for the moving body, or may be used for a stationary body. As shown in the FIGURE, the redox flow battery system includes a battery cell 10, a first circulation mechanism 20, and a second circulation mechanism 30.

The battery cell 10 is a redox flow rechargeable battery, and circulates electrolytic solutions to cause an oxidation-reduction reaction and to perform charging and discharging. The battery cell 10 includes a positive electrode chamber 13 that houses a positive electrode 11 and a negative electrode chamber 14 that houses a negative electrode 12. Each of the positive electrode chamber 13 and the negative electrode chamber 14 is capable of circulating an electrolytic solution supplied from the outside of the battery cell 10. The electrolytic solution supplied to the positive electrode chamber 13 is referred to as a positive electrode electrolytic solution, and the electrolytic solution supplied to the negative electrode chamber 14 is referred to as a negative electrode electrolytic solution.

As the positive electrode 11 and the negative electrode 12, for example, an electron conductor having a large specific surface area such as carbon felt, carbon paper, carbon nanotube sheet, or porous metal can be used. The positive electrode 11 is connected with a positive electrode terminal 15. The negative electrode 12 is connected with a negative electrode terminal 16. The positive electrode terminal 15 and the negative electrode terminal 16 are connected to a charging and discharging device, which is not shown. The charging and discharging device applies a voltage to the positive electrode 11 and the negative electrode 12 when charging the battery cell 10, and extracts electric power from the positive electrode 11 and the negative electrode 12 when discharging the battery cell 10.

Inside the battery cell 10, a separator 17 that partitions the positive electrode chamber 13 and the negative electrode chamber 14 is provided. The separator 17 separates the positive electrode chamber 13 and the negative electrode chamber 14. The separator 17 is a film-shaped porous body. The separator 17 has a large number of pores that connect the positive electrode chamber 13 and the negative electrode chamber 14.

As the separator 17, a porous film such as a PP microporous film, a PE microporous film, or a nonwoven fabric separator can be used. As the PP microporous film, for example, a product name “CELGARD” manufactured by Asahi Kasei Corporation can be used. As the PE microporous film, for example, the product name “HIPORE” manufactured by Asahi Kasei Corporation can be used.

The first circulation mechanism 20 circulates the positive electrode electrolytic solution into the positive electrode chamber 13 of the battery cell 10. The first circulation mechanism 20 includes a positive electrode side tank 21, a positive electrode side pipe 22, a positive electrode side pump 23, and a positive electrode side filter 24. The positive electrode side tank 21 stores the positive electrode electrolytic solution.

The positive electrode side tank 21 is provided with an inflow portion 21a into which the positive electrode electrolytic solution flows in and an outflow portion 21b from which the positive electrode electrolytic solution flows out. The positive electrode electrolytic solution in the positive electrode side tank 21 is circulated into the positive electrode chamber 13 of the battery cell 10 via the positive electrode side pipe 22.

The positive electrode side pump 23 is provided to the positive electrode side pipe 22 and sends out the positive electrode electrolytic solution. The positive electrode side filter 24 is provided at the outflow portion 21b of the positive electrode side tank 21. The positive electrode electrolytic solution of the positive electrode side tank 21 contains an active material, and the positive electrode side filter 24 restricts outflow of the electrode active material from the positive electrode side tank 21. The positive electrode side filter 24 corresponds to a positive electrode side active material separator of the present disclosure.

The second circulation mechanism 30 circulates the negative electrode electrolytic solution into the negative electrode chamber 14 of the battery cell 10. The second circulation mechanism 30 includes a negative electrode side tank 31, a negative electrode side pipe 32, a negative electrode side pump 33, and a negative electrode side filter 34. The negative electrode side tank 31 stores the negative electrode electrolytic solution.

The negative electrode side tank 31 includes an inflow portion 31a into which the negative electrode electrolytic solution flows in and an outflow portion 31b from which the negative electrode electrolytic solution flows out. The negative electrode electrolytic solution in the negative electrode side tank 31 is circulated into the negative electrode chamber 14 of the battery cell 10 via the negative electrode side pipe 32.

The negative electrode side pump 33 is provided to the negative electrode side pipe 32, and sends out the negative electrode electrolytic solution. The negative electrode side filter 34 is provided at the outflow portion 31b of the negative electrode side tank 31. The negative electrode electrolytic solution of the negative electrode side tank 31 contains an active material, and the negative electrode side filter 34 restricts outflow of the active material from the negative electrode side tank 31. The negative electrode side filter 34 corresponds to a negative electrode side active material separator of the present disclosure.

Here, the positive electrode electrolytic solution and the negative electrode electrolytic solution will be described. The same kind of electrolytic solution may be used for the positive electrode electrolytic solution and the negative electrode electrolytic solution. Hereinafter, the positive electrode electrolytic solution and the negative electrode electrolytic solution may be collectively referred to as “electrolytic solution.”

As a solvent of the electrolytic solution, for example, propylene carbonate, ethylene carbonate, dimethyl carbonate, diethyl carbonate, acetonitrile, dimethyl sulfoxide (DMSO), diglyme, triglyme, or tetraglyme can be used.

As an electrolyte of the electrolytic solution, for example, a salt containing carrier ions such as hexafluorophosphate (PF₆ salt), borate (BF₄ salt) and bistrifluoromethanesulfonylimide (TFSI salt) can be used. As the carrier ions, ions having charges such as Li⁺, Na⁺, K⁺, Mg²⁺, and Ca²⁺ can be used. In the present embodiment, Li⁺ is used as the carrier ions.

Each of the positive electrode electrolytic solution and the negative electrode electrolytic solution contains the active material. The active material is a material capable of occluding and releasing carrier ions. The active material is in a solid state in the electrolytic solution. The active material can be in the form of powder or pellets. In the present embodiment, a substance capable of occluding and releasing Li by a potential change is used as the active material.

The positive electrode electrolytic solution contains a positive electrode active material. As the positive electrode active material, for example, LiFePO₄ (LFP), LiMn₂O₄, LiNi_{0.5}Mn_{1.5}O₄, LiMn_{0.8}Fe_{0.2}PO₄, or the like can be used.

The negative electrode electrolyte contains a negative electrode active material. As the negative electrode active material, for example, Li₄Ti₅O₁₂ (LTO), Sb, Sn, Si, graphite, TiO₂ or the like can be used.

The positive electrode active material is present inside the positive electrode side tank 21, and the negative electrode active material is present inside the negative electrode side tank 31. As described above, the positive electrode side filter 24 restricts the outflow of the positive electrode active material from the positive electrode side tank 21. Therefore, the positive electrode active material is not supplied to the positive electrode chamber 13 of the battery cell 10. Similarly, the negative electrode side filter 34 restricts the outflow of the negative electrode active material from the negative electrode side tank 31. Therefore, the negative electrode active material is not supplied to the negative electrode chamber 14 of the battery cell 10.

The electrolytic solution contains a mediator having redox activity. The mediator is a redox medium that mediates electrons, and is a redox mediator that mediates other reactions by its own redox reaction. The mediator of the present embodiment is configured as dissolved particles dissolved in the electrolytic solution or dispersed particles dispersed in the electrolytic solution. The mediator contained in the positive electrode electrolytic solution can pass through the positive electrode side filter 24. The mediator contained in the negative electrode electrolytic solution can pass through the negative electrode side filter 34.

The mediator of the present embodiment is a polymer compound having a redox substituent that is a functional group capable of causing a reversible redox reaction. Examples of redox substitutes include nitroxyl radicals, quinone derivatives, metallocene derivatives, carbazole derivatives, anthracene derivatives, diazole compounds, phenazine derivatives, disulfides, aryl derivatives and the like.

The positive electrode electrolytic solution contains a positive electrode mediator, and the negative electrode electrolytic solution contains a negative electrode mediator. Each of the positive electrode mediator and the negative electrode mediator includes a charging mediator used when the battery cell 10 is charged and a discharging mediator used when the battery cell 10 is discharged.

The positive electrode mediators for charging and discharging and the negative electrode mediator for charging and discharging have no essential difference, and are determined by the magnitude relationship of the potential with the active materials. The equilibrium potentials of the positive electrode active material, the negative electrode active material, the positive electrode mediators, and the negative electrode mediators have a relationship of the negative electrode mediator for charging<the negative electrode active material<the negative electrode mediator for discharging<the positive electrode mediator for discharging<the positive electrode active material<the positive electrode mediator for charging.

Different types of mediators may be used as the mediator for charging and the mediator for discharging. Alternatively, one type of mediator having two equilibrium potentials may be used as both the mediator for charging and the mediator for discharging.

In the present embodiment, as the mediator, a polymer compound having a bottle brush structure is used. In the bottle brush structure, macromonomers bonded with the redox substituent are polymerized to a main chain. The bottle brush structure polymer compound is a comb-shaped polymer in which branched chains are introduced at high density, and redox substituents, which are active sites, are continuously arranged. The polymer compound having the bottle brush structure is easily dispersed in the electrolytic solution, and can reduce the viscosity of the electrolytic solution as compared with the linear polymer compound.

Examples of two types of positive electrode mediators and three types of negative electrode mediators are shown below.

A first positive electrode mediator is Poly[4-{5-(5,10-dihydro-10-methylphenazine)methyl}styrene represented by the following chemical formula (1). The first positive electrode mediator has an equilibrium potential of 3.75V and 3.1V, and can be used as both the mediator for charging and the mediator for discharging. The equilibrium potential is based on the dissolution/precipitation potential (vs. Li+/Li) of Li metal.

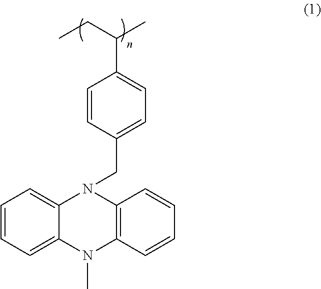

A second positive electrode mediator is Poly(norbornene)-g-poly(4-methacryloyloxy-2,2,6,6-tetramethylpiperidin-1-oxyl) (PNB-g-PTMA) represented by the following chemical formula (2).

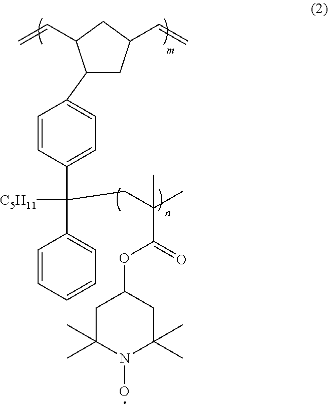

In the PNB-g-PTMA represented by the chemical formula (2), a portion of poly(4-methacryloyloxy-2,2,6,6,6-tetramethylpiperidin-1-oxyl) shown below is used for discharging.

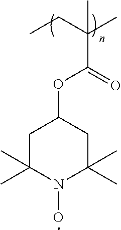

A first negative electrode mediator is Poly(2-vinyl-9H-fluoren-9-one) represented by the following chemical formula (3). The equilibrium potential of the first negative electrode mediator is 1.9V.

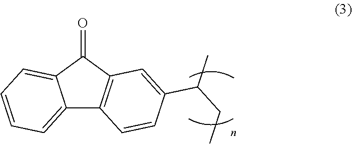

A second negative electrode mediator is Poly(2,1,3-benzazodiazole-substituted acrylamide) represented by the following chemical formula (4).

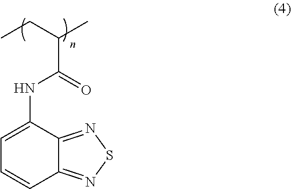

A third negative electrode mediator is poly(2-(benzo[c][1,2,5]thiadiazol-4-yl)-3a,4,7,7a-tetrahydro-1H-4,7-methanoisoindole-1,3(2H)-dione) represented by the following chemical formula (5).

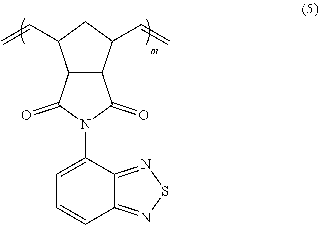

In the present embodiment, LiFePO₄ (equilibrium potential 3.45 V) is used as the positive electrode active material, and TiO₂ (equilibrium potential 1.8 V) is used as the negative electrode active material. In this case, the first positive electrode mediator can be suitably used as the positive electrode mediator, and the first negative mediator and the third negative mediator can be suitably used as the negative mediator.

Here, a relationship between diameters of the mediators and a pore diameter of the separator 17 will be described. The diameters of the mediators are larger than the pore diameter of the separator 17. Therefore, the positive electrode mediator and the negative electrode mediator are restricted from passing through the separator 17. In the present embodiment, the mediators have diameters of about 90 nm, and the separator 17 has a pore diameter of about 20 nm.

In the present embodiment, a pore distribution d50 is used as the pore diameter of the separator 17. That is, the diameters of the mediators are larger than the pore distribution d50 of the separator 17.

The pore distribution represents a relationship between the pore diameter and the volume. The pore distribution of the separator 17 can be determined by, for example, an isothermal adsorption line measurement such as the BET method, or by directly observing a microscope image such as an SEM image. The pore distribution d50 means the pore diameter when the volume is integrated from the pore having the smaller pore diameter in the pore distribution to reach 50% of the total pore volume. That is, the pore distribution d50 means the pore diameter corresponding to the median of the pore distribution.

If the mediators are dispersed particles, the mediator diameters are particle diameters. On the other hand, when the mediators are dissolved polymers dissolved in the electrolytic solutions, the diameters of the mediators can be obtained from the hydrodynamic radius. The hydrodynamic radius is expressed using the intrinsic viscosity number and the molecular weight. The intrinsic viscosity number is the amount of increase in viscosity when one polymer is dissolved in an infinite solvent, As the intrinsic viscosity number, a value obtained by plotting the increase rate of viscosity and the mass concentration of the polymer and extrapolating the mass concentration to 0 is used.

Assuming that the intrinsic viscosity is [η], the molecular weight of the polymer is M, and the Avogadro number is N_{A}, the hydrodynamic radius R_{H} can be expressed by the following equation 1.

$${R}_{H} = {( \frac{[ η ] M}{2.5 {N}_{A}} )}^{1 / 3} \qquad [ Equation 1 ]$$

The separator 17 restricts passage of the positive electrode mediator and the negative electrode mediator. Further, the separator 17 allows the movement of carrier ions between the positive electrode chamber 13 and the negative electrode chamber 14.

According to the present embodiment described above, in the redox flow battery system using the mediators, the polymer compound is used as the mediators, and the diameters of the mediators are set to be larger than the pore diameter of the separator 17. Accordingly, even when the porous film is used as the separator 17, it is possible to restrict the positive electrode mediator and the negative electrode mediator from being mixed with each other.

Further, by using the porous film as the separator 17, the ionic conductivity can be made higher than that in the case of using the electrolyte film. Thereby, the power density of the redox flow battery system can be increased. This is particularly effective when the redox flow battery system is used in a moving body with a limited mounting space.

Further, in a redox flow battery system that does not use a mediator, a concentration of an electrolytic solution is proportional to the energy density. Therefore, in order to increase the output, it is necessary to increase the concentration of the electrolytic solution, and as a result, the viscosity of the electrolytic solution increases. On the other hand, in the redox flow battery system using the mediator as in the present embodiment, most of the factors that determine the energy density is the amount of the active material, and the energy density can be increased even if the concentration of the electrolytic solution is low. Therefore, in the redox flow battery system of the present embodiment, the viscosity of the electrolytic solution can be reduced. Furthermore, since the polymer compound having the bottle brush structure, which is used as the mediators in the present embodiment, is easily dispersed in the electrolytic solution, the viscosity of the electrolytic solution can be reduced.

Moreover, since the diffusion resistance is reduced due to the decrease in the viscosity of the electrolytic solution, the cell resistance can be decreased and the reactivity between the active material and the mediator can be improved.

In addition, the pressure loss can be reduced due to the decrease in the viscosity of the electrolytic solution. Accordingly, the power consumption of the pumps 23 and 33 can be reduced.

Further, in the redox flow battery system using the mediator, energy is transferred by contact between the mediator and the active material in each of the tanks 21 and 31. When a low molecule is used as the mediator, only the molecule in contact with the active material reacts, and the reaction rate is low. On the other hand, in the polymer compound used as the mediator in the present embodiment, active sites enabling redox reaction are concentrated at a high density. Therefore, the reaction speed can be improved by simultaneously reacting the entire polymer compound.

Further, in the present embodiment, the polymer compound having the bottle brush structure is used as the mediator. Since the polymer compound having the bottle brush structure has active sites arranged in series, a chain reaction is likely to occur. Therefore, the reaction speed can be increased.

### OTHER EMBODIMENTS

The present disclosure is not limited to the embodiment described hereinabove, but may be modified in various ways as hereinbelow without departing from the gist of the present disclosure. The means disclosed in each of the above embodiments may be appropriately combined to the extent practicable.

For example, in the above-described embodiment, the organic polymer compound is used as the mediators, but the mediators are not limited to this, and a metal organic structure (MOF) or a carbon nanotube occluding a redox body may also be used as the mediators.

Further, in the above-described embodiment, both the positive electrode 11 and the negative electrode 12 of the battery cell 10 are configured as a flow battery that circulates the electrolytic solution. However, not limited to this, only one of the positive electrode 11 and the negative electrode 12 of the battery cell 10 may be configured as a flow battery. In such a case, the other electrode may be configured like a lithium ion battery.

What is claimed is:

1. A redox flow battery system comprising:
a redox flow battery cell including a positive electrode chamber housing a positive electrode, a negative electrode chamber housing a negative electrode, and a separator separating the positive electrode chamber and the negative electrode chamber;
a first circulation mechanism configured to circulate a positive electrode electrolytic solution into the positive electrode chamber; and
a second circulation mechanism configured to circulate a negative electrode electrolytic solution into the negative electrode chamber, wherein
the positive electrode electrolytic solution contains a positive electrode active material and a positive electrode mediator,
the negative electrode electrolytic solution contains a negative electrode active material and a negative electrode mediator,
the separator is a porous body, and
each of the positive electrode mediator and the negative electrode mediator has a diameter larger than a pore distribution d50 of the separator.

2. The redox flow battery system according to claim 1, wherein
the first circulation mechanism includes a positive electrode side tank storing the positive electrode electrolytic solution and a positive electrode side active material separator disposed at an outlet portion of the positive electrode side tank,
the second circulation mechanism includes a negative electrode side tank storing the negative electrode electrolytic solution and a negative electrode side active material separator disposed at an outlet portion of the negative electrode side tank,
the positive electrode active material is in a solid state in the positive electrode electrolytic solution and is disposed in the positive electrode side tank,
the negative electrode active material is in a solid state in the negative electrode electrolytic solution and is disposed in the negative electrode side tank,
the positive electrode side active material separator is configured to restrict outflow of the positive electrode active material from the positive electrode side tank and allow outflow of the positive electrode mediator from the positive electrode side tank, and
the negative electrode side active material separator is configured to restrict outflow of the negative electrode active material from the negative electrode side tank and allow outflow of the negative electrode mediator from the negative electrode side tank.

3. The redox flow battery system according to claim 1, wherein
each of the positive electrode mediator and the negative electrode mediator is a polymer compound including a redox substituent that is a functional group capable of causing a reversible redox reaction.

4. The redox flow battery system according to claim 3, wherein
the polymer compound has a bottle brush structure, and
in the bottle brush structure, macromonomers bonded with the redox substituent are polymerized to a main chain.

5. The redox flow battery system according to claim 2, wherein
each of the positive electrode mediator and the negative electrode mediator is a polymer compound including a redox substituent that is a functional group capable of causing a reversible redox reaction.

6. The redox flow battery system according to claim 5, wherein
the polymer compound has a bottle brush structure, and
in the bottle brush structure, macromonomers bonded with the redox substituent are polymerized to a main chain.
